(19) United States
(12) Patent Application Publication
(10) Pub. No.: US 2018/0242539 A1
(43) Pub. Date: Aug. 30, 2018

(54) An Intelligent Integrated Plant Growth System and a Process of Growing Plant Thereof

(71) Applicants: Deb Ranjan Bhattacharya, Gurgaon (IN); Tulika Bhattacharya, Gurgaon (IN)

(72) Inventors: Deb Ranjan Bhattacharya, Gurgaon (IN); Tulika Bhattacharya, Gurgaon (IN)

(21) Appl. No.: 15/127,502

(22) PCT Filed: Mar. 20, 2015
(86) PCT No.: PCT/IN2015/000136

§ 371 Date: Sep. 20, 2016

(30) Foreign Application Priority Data
Mar. 21, 2014 (IN) 825/DEL/2014

(51) Int. Cl. A01G 31/02; A01G 7/04; A01G 9/24; A01G 29/00

(52) U.S. Cl. CPC A01G 31/02; A01G 29/00; A01G 9/24; A01G 7/045

(57) ABSTRACT

An intelligent integrated plant growth system and a process of growing plant thereof comprising of a plant growth chamber, nutrition control unit, lighting control unit, climate control unit, imaging unit, power unit and interfacing unit to receive an input from user, which is processed by central control unit, thereby passing it to a primary control unit to output a control signal. The primary control unit is connected to a secondary control unit, nutrition control unit, lighting control unit, climate control unit, imaging unit and power unit through a feedback network, which provides a feedback input to the primary control unit. The primary control unit processes the input and feedback input to output control signal, which controls the secondary control unit, nutrition control unit, lighting control unit, climate control unit, imaging unit and power unit based on feedback input and input from interfacing unit, thereby forming intelligent integrated plant growth system.

### FIELD OF INVENTION

The present invention relates to an intelligent integrated plant growth system and a method for growing plant thereof. More particularly, the present invention relates to an intelligent integrated aeroponic system for growing plants under controlled condition like temperature, climate, light or the like.

### BACKGROUND

Since the evolution of mankind from hunters and gatherers, to agrarian societies, the direction of efforts has been mainly directed towards two or three direction, one is towards improving the yield and productivity by either genetic changes, or cultural or husbandry, and management practices, and by developing and introducing plant protection measures. Its only in the last century and this century at the peak of industrial revolution, that people have started exploring the possibilities of soil less and protected agriculture in glass houses and greenhouses, and trying to mechanize it to prevent the crop losses due to soil borne diseases and pests. The Hydroponic technologies to grow initially leafy green vegetables were the first to emerge, which started taking commercial exploitation routes in industrialised countries in west and in east, but eventually were found to have certain defects and problems that forced people to discover and experiment with newer variations and techniques like aeroponics. The aeroponics method provides better control into the plant growth and nutritional availability and prevents the plant from various disesases and root rot etc. However the methods adopted in the aeroponics requires high level of manual interference and involvement in terms of physical presence and expertise in domain knowledge of plants, environment control, operations and to maintain and control the growth of the plant. Thereby making the system more complicated and complex and more time consuming with high man power and expertise training and skill, for larger aeroponic systems.

This problem has been tried to be resolved in U.S. Pat. No. 7,823,328B2, which discloses a closed loop aeroponic system with closed loop nutrition supplying lines, with a filter before the used nutrtient fluid is drained into the nutrient reservoir, while the plants grow in cylindrical chambers, which provides less air in the root chamber. This system although controls the pH and EC, however fails in providing a complete control of the nutrition like the nutrient temperature, which is an important aspect of plant growth, and effects the plant metabolism, growth and survival during water stress, and nutrient availability in hot tropical climates, while the other external climate variables like temperature, humidity, light etc are beyond the scope and control of this apparatus, besides this also demands a constant monitoring of plants, to prevent any system failure and plant husbandry knowledge and expertise of the user.

The U.S. Pat. No. 4,992,942 discloses a method and apparatus for nutrient control system for crops in the field based on actual and projected data from the various sensors and weather data based on predefined rules. The system however fails to disclose the problem associated with the weather and micro climatic changes, which therefore requires skilled person physical presence to overcome.

Further, the US20120277117 A1 discloses a hydroponic apparatus and its method of use for high throughput screening of plants by visual assessment, imaging, chemical or biological or physical assay, but none of the parts related to visual assessment, imaging, chemical, physical or biological assay seem to be physically integrated into the hydroponic apparatus as a one whole unit. Besides, hydroponics system fails to meet the disadvantages, especially related to changed natural conditions and morphology like the matted roots, root death, and increased risk of bacterial and fungal diseases, which therefore requires skilled manpower or manforce to physical monitor such problems and for its resolution.

It would therefore be advantageous to have a plant growth system to overcome the above-mentioned drawbacks and/or to have various other benefits and advantages.

### SUMMARY

One embodiment of the present invention discloses an intelligent integrated plant growth system comprising of a plant growth chamber having at least a tray with a base adapted to hold at least a plant, a distributing structure to distribute a nutritional fluid within said tray to the roots of said plant and a draining structure to drain said nutritional fluid from said base of said tray. The plant growth chamber has an unique advantage as it is capable of providing control and management of all the possible external plant growth parameters very precisely, i.e. provide a completely conditioned plant growth environment at each stage of almost any plant's life cycle. The plants respond more positively to a different set of ideal growth conditions in the system of our invention in terms of growth rate, biomass accumulation, and other phenotypic traits, and physiological and health parameters.

A nutrition control unit having a reservoir adapted to store said nutritional fluid from said draining structure, a condensing unit configured to condense the water vapor into water with least impurities to form said nutritional fluid stored in said reservoir, a pumping unit configured to pump said nutritional fluid from said reservoir to said tray through said distributing structure, while the nutrition control unit is configured to control the timing of the pumping of said pumping unit to pump said nutritional fluid from said reservoir at predefined intervals.

A lighting control unit configured to provide at least a light ray of a predefined wavelength and of a predefined photosynthetic property for the growth of said plant, said predefined wavelength and said predefined photosynthetic property of said light ray is controlled by the secondary control unit. Thereby providing an ideal lighting conditions relevant to the growth stage in life cycle, specific for a plant species and variety, in each shelf, or tray at each level, independent of the other shelf or tray.

A climate control unit configured to control at least a parameter for the growth of said plant in said plant growth chamber. An imaging unit configured to image said plant at predefined intervals and analysing the phenotypic, physiological and the like growth and development parameters of said plant.

A power unit configured to supply electric power for the functioning of said intelligent integrated plant growth system for the growth of said plant.

An interfacing unit configured to receive an input from a user, said input is processed by a central control unit, thereby passing processed said input to a primary control unit configured to output a control signal, said primary control unit is connected to at least any one of said nutrition control unit, said lighting control unit, said climate control unit, said imaging unit and said power unit through a feedback network, said feedback network provides a feedback input from at least any one of said nutrition control unit, said lighting control unit, said climate control unit, said imaging unit and said power unit to said primary control unit. The primary control unit processes said input and said feedback input to output said control signal, and said control signal controls at least any one of said nutrition control unit, said lighting control unit, said climate control unit, said imaging unit and said power unit based on said feedback input received from at least any one of said nutrition control unit, said lighting control unit, said climate control unit and said imaging unit and said power unit and said input from said interfacing unit, thereby forming said intelligent integrated plant growth system. The predefined wavelength includes the wavelength in the range of at least any one from Red, Blue, Green, IR, NIR and White light

The distributing structure is within at least any one of said tray and said plant growth chamber to distribute the nutritional fluid to the plant. The plant holder supports said plant on a tray cover of said tray, said tray is provided with a locking system to enable the tray cover to cover said tray to prevent loss of said nutritional fluid and ensuring oxygenation of the roots of said plant.

The central control unit based on said input from said interfacing unit varies at least any one from a nutritional composition, temperature, pH, EC and a level of said nutritional fluid stored in said reservoir, and such other plant growth and development parameters, the said central control unit outputs said control signal to said primary control unit configured to control said at least any one of said nutrition control unit, said lighting control unit, said climate control unit, said imaging unit and said power unit based on said feedback input and said input, said primary control unit outputs the control signal to said secondary control unit configured to control light parameters of said plant.

A temperature control unit having a temperature sensor, and a conditioning unit to maintain predefined temperature, at predefined time, or creation of temporal gradients of temperature for day and night for the growth of said plant in said plant growth chamber. A humidity control unit having a humidity sensor to control the humidity as per predefined level and time for the growth of said plant. A gaseous exchange unit having at least a gas sensor to maintain gaseous balance required for the growth of said plant and a plurality valves to control the exchange of gases to maintain desired gaseous composition with desired duration and frequency. A photosynthetic property includes at least any one from light duration, light intensity and combinations of said predefined wavelength.

The imaging unit imaging unit images said plant to form an image at predefined intervals for image analysis of said plant for at least any one from growth curve analysis, phenotypic analysis, morphometric analysis, physiological analysis and genetic screening due to changes in at least any one from growth parameters and genetic changes, said image of said plant is stored in an image database for analyses using an Image Analysis Software for Plant Morphometry and phenomics. Thereby, enabling the user to analyze and compared the current image with prior data to identify trends and patterns, for subsequent selection or alteration in the management regimes.

The primary control unit is connected to a music unit to provide support to the growth of the plant in said plant growth chamber, and said interface unit is accessed from remote distance using a communicating device.

Another embodiment of the present invention discloses a process for growing a plant in an intelligent integrated plant growth system comprising the steps of placing the plant in a plant growth chamber having at least a tray with a base to hold the plant, controlling a nutritional fluid by a nutrition control unit by storing said nutritional fluid in a reservoir of said nutrition control unit, condensing water vapor into water with least impurities to form said nutritional fluid stored in said reservoir, pumping said nutritional fluid at predefined intervals by a pumping unit from said reservoir to said tray through a distributing structure to distribute said nutritional fluid within said tray to the roots of said plant, and draining said nutritional fluid from said base of said tray by a draining structure to the reservoir of said nutrition control unit, pumping of said pumping unit is controlled by said nutrition control unit, providing at least a light ray of at least a predefined wavelength and of a predefined photosynthetic property by a lighting control unit for the growth of said plant, said predefined wavelength and said predefined photosynthetic property of said light ray is controlled by said secondary control unit, climatizing the plant growth chamber by an climate control unit by controlling at least a parameter for the growth of the plant in said plant growth chamber, imaging said plant by an imaging unit at predefined intervals for analysing the growth of said plant in the plant growth chamber, powering said intelligent integrated plant growth system by a power unit to supply electric power for the functioning of said intelligent integrated plant growth system for the growth of the plant and receiving an input from a user by an interfacing unit, processing said input by a central control unit to output processed said input data passes to a primary control unit configured to output a control signal, said primary control unit is connected to at least any one of said nutrition control unit, said lighting control unit, said climate control unit said imaging unit and said power unit through a feedback network, providing a feedback input by said feedback network from at least any one of said nutrition control unit, said lighting control unit, said climate control unit, said imaging unit and said power unit to said primary control unit and processing said input and said feedback input to output said control signal to control at least any one of said nutrition control unit, said lighting control unit, said climate control unit, said imaging unit and said power unit by said central control unit based on said feedback input and said input from said interfacing unit.

The process also includes providing the light ray of the predefined wavelength in the range of at least any of Red, Blue, Green, IR, NIR and White light. The process also includes distributing said nutritional fluid from the reservoir to the roots of said plant by said distributing structure within at least any one of said tray and said plant growth chamber. The process also includes holding said plant by a plant holder on said tray, said tray is provided with a locking system to enable said tray cover to cover said tray to prevent loss of said nutritional fluid thereby ensuring oxygenation of the roots of said plant. The process further includes varying at least any one from a nutritional composition, temperature, a pH and a level of said nutritional fluid stored in said reservoir, and such other plant growth and development parameters, by said central control unit based on said input from said interfacing unit, said central control unit outputs said control signal to said primary control unit configured to control said at least any one of said nutrition control unit, said lighting control unit, said climate control unit, said imaging unit and said power unit based on said feedback input and said input, said primary control unit outputs the control signal to said secondary control unit configured to control light parameters of said plant.

The process also includes climatizing the plant growth chamber by maintaining: the predefined temperature, at a predefined time, or creation of temporal gradients of temperature for day and night for the growth of said plant by a temperature control unit including a temperature sensor, and a conditioning unit in said climate control unit; the humidity to a predefined level and for a predefined time for the growth of said plant by a humidity control unit including a humidity sensor in said climate control unit; and gaseous balance and gaseous composition with desired duration and frequency required for the growth of said plant by a gaseous exchange unit having at least a gas sensor and a plurality of valves in said climate control unit.

The process also includes providing the light ray with said photosynthetic property including at least any one from light duration, light intensity and combinations of said predefined wavelength. The process also includes imaging the plant to form an image at predefined intervals by said imaging unit for analysing said image of said plant for screening at least any one from growth curve analysis, phenotypic analysis, morphometric analysis, physiological analysis and genetic screening due to changes in at least any one from, growth and development parameters and genetic changes, said image of said plant is stored in an image database for analyses using an image analysis software for plant morphometry and phenomics.

The process includes providing music by a music unit connected to said primary control unit to enhance the growth of said plant and enabling said user to access and control or change said input from remote distance by a communicating device by said interfacing, unit. The process also includes processing said input by said central control unit from said Interfacing unit to vary at least any one of a plant growth parameters from nutritional composition, nutritional concentration, temperature, pH, level of the fluid stored in said reservoir, frequency and dose, Light intensity of said light ray, duration of providing the light ray, the predefined wavelength, predefined photosynthetic property, air temperature, air velocity, air composition, humidity percentage, sound frequency, sound volume, sound wavelength, sound composition and the like.

### BRIEF DESCRIPTION OF DRAWINGS

FIG. 1 discloses an embodiment of the present invention depicting schematic view of the intelligent integrated plant growth system

FIG. 2 discloses an embodiment of the present invention depicting data flow diagram of the signal in the intelligent integrated plant growth system.

| Description of Elements | Reference Numeral |
|---|---|
| An intelligent integrated plant growth system | 10 |
| Plant growth chamber | 20 |
| Tray | 22 |
| Base | 24 |
| Distributing structure | 26 |
| Spray Nozzle | 27 |
| Draining structure | 28 |
| Drain filter | 29 |
| Plant | 30 |
| Plant holder | 32 |
| Tray cover | 34 |
| Locking system | 36 |
| Nutrient dispenser | 40 |
| Nutrient mixer | 41 |
| Reservoir | 42 |
| Nutrient pH & EC sensor | 43 |
| Nutrient level sensor | 44 |
| Temperature sensor for nutritional fluid | 45 |
| Nutrient conditioning unit | 46 |
| Pumping unit | 47 |
| Nutrition controller unit | 48 |
| Lighting control unit | 50 |
| Light intensity sensor | 51 |
| LED panel | 52 |
| LED dimmer | 54 |
| LED light controller | 56 |
| LED | 58 |
| Climate control unit | 60 |
| Temperature control unit | 61 |
| Temperature & Humidity sensor | 62 |
| Compressor | 63 |
| Condenser | 64 |
| Air filter | 65 |
| Gas sensors | 66 |
| Gaseous exchange unit | 67 |
| Humidity control unit | 68 |
| Fan | 69 |
| Imaging unit | 70 |
| Image database | 71 |
| Camera carriage unit | 72 |
| Imaging control unit | 73 |
| Music unit | 76 |
| Music file database | 77 |
| Speaker | 78 |
| Communicating device | 79 |
| Power unit | 80 |
| Interfacing unit | 90 |
| Expert system | 91 |
| Central control unit | 92 |
| Primary control unit | 94 |
| Secondary control unit | 96 |
| Database store | 98 |

### DETAILED DESCRIPTION OF THE EMBODIMENTS

The embodiments of the present invention can be understood by reading following detailed description of some of the embodiments with reference to the accompanying drawings.

In an embodiment of the present invention, an intelligent integrated plant growth system (10) and a process of growing plant thereof comprises of a plant growth chamber (20) with multiple number of trays (22) or shelf. The intelligent integrated plant growth system (10) is an expert knowledge based system, which enables the growth of plants (30) in a totally controlled environment. The environment is controlled by controlling the various subsystems of the intelligent integrated plant growth system (10), namely, thereby controlling 21 different environmental parameters. These parameters include:
1. Day Air Temperature (Max, Min) Fixed or Gradient
2. Night Air Temperature (Max, Min) Fixed or Gradient
3. Temperature Range in Day and Night
4. Relative Humidity (Max, Min)
5. Light—White Full Spectrum
6. Light Wavelength (Color) Ratiometric Composition at Tray/Shelf level in terms of Individual Intensity
7. Light Total Intensity Control at shelf or tray level
8. Light Duration
9. Light PAR Level at different plant height (calculated)
10. Light Intensity Temporal Gradient
11. Light IR or NIR Control
12. Air Exchange Interval & Duration
13. Gaseous Composition Control (CO₂ Supplementation)
14. Root Zone Temperature Control by Heating/Cooling Nutrient Fluid
15. Nutrient Solution Quantity Control
16. Nutrient Solution Composition & Concentration Control
17. Nutrient Solution Spray Duration & Interval Control
18. Nutrient Solution pH Control
19. Nutrient Solution EC Control
20. Water Availability Control
21. Root Zone Oxygen/Aeration

The intelligent integrated plant growth system (10) provides both custom developed cultivation parametric control recipes on a temporal scale for specific crops and for varieties. The system (10) is based on an Embedded electronics architecture with Master Control Board or Primary Control Unit (94) and Slave Control Boards or Secondary Control Boards (96), which are interfaced through a 32 bit computer or thye Central Control Unit (91) with an interactive GUI Interfacing Unit (90) for programming the system (10). The system allows both development and creation of user defined plant growth recipes, or pre stored and predefined recipes stored in the database store (98), and can be just recalled and run.

The subsystems are controlled by the primary control unit (94) and the secondary control unit (96). These subsystem includes plant growth chamber (20), Nutrition control unit (48), Lighting control unit (50), climate control unit (60), imaging unit (70), power unit (80), music unit (76), central control unit (92) and interfacing unit (90) and primary control unit (94) and secondary control unit (96). All these subsystems are housed in a heat insulated housing made up of PUF (Poly Urethane Foam) which maintains the heat inside with rubber gasket to prevent any heat loss to the external environment, except the climate control unit's Temperature Control Unit, that is uninsulated and the back side is fenestrated with louvres.

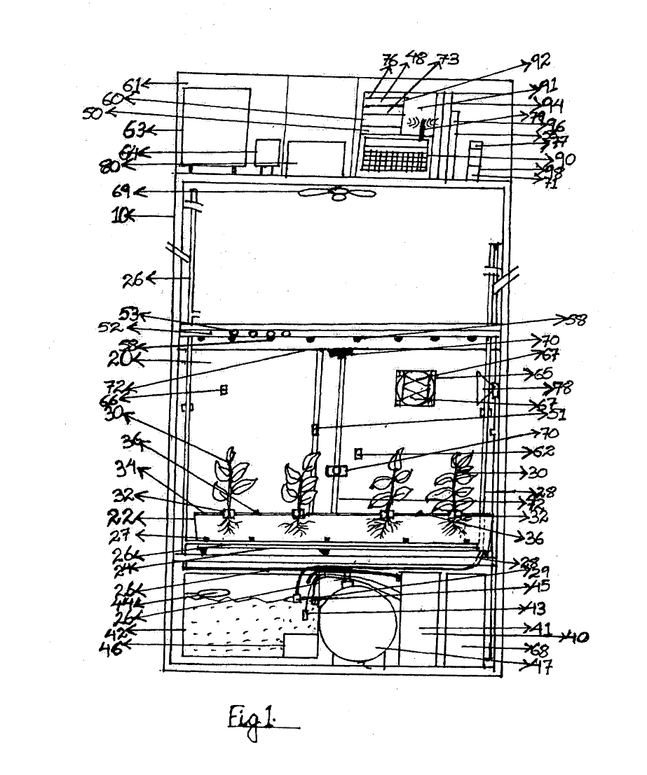

As shown in FIG. 1, the plant growth chamber (20) has multiple numbers of trays (22) or multiple numbers of shelves. These trays (22) have a base, which is adapted to hold one or more number of plants (30). A distributing structure (26) is structured within the trays (22) or within the plant growth chamber (20). The distributing structure (26) distributes the nutritional fluid to the roots of the plants (30). The nutritional fluid in excess moves to the base (24) from the root. The roots of the plant (30) hang in air, while the plants (30) are supported and held in the tray (22) through a plant holder (32). The plant holder (32) is made of polymeric foam or other such materials, which absorbs moistures and acts as plant support system and simultaneously preventing the loss of the nutritional fluid as spray mist. The nutritional fluid after fertigating the root of the plant (30) accumulates on the sloping side of the base (24) of the tray (22), which is then drained from the base (24) by the draining structure (28) by gravity. This draining structure (28) drains the nutritional fluid into the reservoir (42) of the nutrition control unit (48). The reservoir (42) is adapted to stores the nutritional fluid. The nutritional control unit (48) may have a condensing unit, which condenses the air or the water vapor in the air into water, thereby forming the nutritional fluid of least impurities, the water required for nutrition fluid reconstitution, can be also from an RO source which can be externally located. The nutritional fluid upon receiving from the draining structure (28) is filtered through drain filter (29) and further cooled or warmed using the nutrient conditioning unit (46), which can act as both i.e. as a chiller or warmer like peltier based solid state devices and the like devices, as per the set temperature. The root zone cooling and low temperature nutritional fluid helps plants (30) offset or to withstand high air temperatures. The nutrient temperature, nutrient fluid pH and its level are monitored by the temperature sensor for the nutrient fluid (45), Nutrient pH and EC sensor (43) and nutrient level sensor (44) respectively. They are also controlled and are user defined. An alarm can be set to alert the user in case of required condition is achieved.

Thus, the Nutrition control unit (48) can both reconstitute the nutritional fluid drawing the nutritional concentration from the concentrate containers through nutrient dispensers (40), and adjust the pH and EC based on the feedback of the nutrient pH and EC sensors (43) in the reservoir (42), based on the set pH and EC value. Thereby enabling the nutritional unit (48) capable of changing or adjusting the nutritional composition, and the plant feeding frequency and duration depending on the specific plant growth recipe of the experts system's knowledgebase or requirement for different stages of the life cycle.

Nutrition control unit (48) also has a pumping unit (47) configured to pump the nutritional fluid from the reservoir (42) to the tray (22) through the distributing structure (26). The pump of the pumping unit (47) creates a high pressure. The nutritional fluid from the reservoir (42) is pumped into the tray (22) through the distributing structure (26), which has holes with the jet spray nozzle (27) having a filter to prevent any plant root debris to enter or clog the nozzle orifice. The spray nozzle (27) is made up of plastic material that is non reactive to the plant nutrients, and is food grade, this prevents any mineral deposition and nozzle clogging, which is a common problem. The spray nozzle (27) enables the nutritional fluid to come out in the form of jets or sprays. At predefined pressure the nutritional fluid can create a mist of desired droplet size between 10 to 100 micrometer, which when comes out of the spray nozzles (27) into the tray's (22) root zone can pass easily between the roots and feed them.

The timing of the pumping unit (47) to pump the nutritional fluid is controlled by the nutrition control unit (48), based on the input received by the user through the interfacing unit (80). The user inputs the predefined intervals for controlling the on and off of the pumping unit (47) through the interfacing unit (80) of the central control unit (92), the input data is then further processed and signal generated by the primary control unit (94) and executed by the nutrition control unit (48) to control the pumping unit (47). This is continued as a cycle as per the requirement and fed instructions. Thereafter, the feedback network continuously updates the user with the current status of the desired parameters like duration of the pumping. Thus, the nutritional fluid is sprayed for a specific duration when the pumping unit (47) is on and then is switched off for the rest of the cycle period.

The plants (30) are uniformly or equally placed with each other or with the spray nozzle (27) to cover the entire volume of the tray (22). There can be plurality of the trays (22) of any suitable size with a locking system (36) for the tray cover (34). The locking system (36) enables the tray cover (34) to cover the tray (22), thereby preventing the loss of nutritional fluid in form of mist or fog, but at the same time ensuring air exchange within the tray (22) to ensure the roots are well oxygenated.

The intelligent integrated plant growth system (10) also includes a lighting control unit (50), which is configured and designed to provide one or more light rays for the growth and development of the plant (30). The lighting control unit (50) can provide ideal lighting conditions relevant to the growth stage in life cycle of the plant (30), specific for a plant species and variety, in each shelf, or tray (22) at each level, independent of the other tray (22) or shelf. The lighting control unit (50) controls at least an LED panel (52), which has multiple number of LEDs (58) i.e. light emitting diode, which are so chosen to provide the max lumens/watt, and predefined wavelength which includes the wavelength of Red, Green and IR or Near IR (NIR) range, which are used to provide required intensity and ratiometric composition of lights to individually to each plants (30) in the tray (22). The predefined wavelength, the predefined photosynthetic property and intensity of the light ray is controlled by the secondary control unit (96) through LED light controller (56) or through LED Dimmers (53), individually in each LED Panel (52) shelf. The photosynthetic property may include light duration, light intensity, and combination of the predefined wavelengths, which are user defined, and all are regulatable and programmable through the interfacing unit (90), through the LED light controllers (56), which may vary as per the type of the plants (30) and its photoperiodism and light requirements which again varies between plant species and varieties, and even with their growth and development phases. The lighting control unit (50) receives inputs from a light intensity sensor (51) connected to secondary control unit (96) which enables the user to know exactly the total light intensity available to the plants at a particular height on a particular shelf. The information received from such ligth intensity sensor (51) is utilised to plan whether any change is required in the system with respect to lighting like, adjustment of shelf height or the height of the LED Panel or the light intensity adjustments, and its associated parameters. Thus, enabling controlling temporally the total light duration, intensity, and even light composition, i.e. composition of relevant light wavelengths, their specific individual and comparative intensity ratio in a 24 hour cycle. Also a temporal gradient of total intensity, over the total light duration, for 24-hour cycle can be created. As different plants absorb and reflect differently in the different color bands, so the user can choose the appropriate intensity suitable for the plant species, besides NIR and IR. The NIR is required in specific stages of the life cycle for the optimal development, which can also be chosen and used, only for that specific phase in the life cycle, whereas, IR can be used in specific duration of 24 hour day period. Besides the individual colors, the intensity of the colors of LED (58) or IR or NIR can also be dimmed or increased through independent LED Dimmer (54) for each color band at each tray (22) or shelf level. The LED panels (52) has a proprietory air based cooling to cool the heat dissipated.

The system (10) is also provided with a climate control unit (60) configured to control various parameters of the growth and development of the plant (30) in the plant growth chamber (20). The parameters like temperature, in different stages of the life cycle, different maximum and minimum temperatures in different parts or segments of the 24 hour day etc. with possibility of creating a temporal temperature gradient in each segment of the day can be controlled and thereby bringing it close to the natural conditions of the outside climate. Similar parameters like humidity, gaseous concentration like CO₂ etc. can be temporally controlled in a fixed and temporal gradient fashion. The climate control unit (60) includes a temperature control unit (61), a humidity control unit (68) and a gaseous exchange unit (67). The temperature control unit (61) has a conditioning unit, which is a mechanical refrigerant based air conditioning system. The conditioning unit maintains the predefined temperature, at predefined time, or creation of temporal gradients of temperature for day and night for the growth of the plant (30) in the plant growth chamber (20). These predefined temperature can be defined by the user through the interfacing unit (90). The conditioning unit comprises of one or more number of compressors (63) and condensers (64), besides the other relevant parts required in an air conditioning system, which can also heat or cool both ways as per the plants growth needs. The temperature control unit (61) and the humidity control unit (68) also have a temperature and humidity sensor (62), which enables the user to know the exact temperature and the humidity by sensing the current temperature and humidity. The humidity sensor along with the humidifier in the humidity control unit (68) controls the humidity as per predefined level and time for the growth of the plant (30) based on the program logic within the plant growth chamber (20). The humidity sensor also informs the exact humidity to the user and to the primary control unit (94).

The gaseous exchange unit (67) has one or more gas sensors (66) to maintain the gaseous balance required for the growth of the plant (30) by sensing the concentration of the available gases like O₂, CO₂ or the like which are essential for the growth and development of the plant (30). The gaseous exchange unit (67) also has two valves or manifolds, which controls the exchange of gases to maintain desired gaseous composition with desired duration and frequency. These valves are solenoid in nature for the air exchange and CO₂ supplementation. The CO₂ is provided from a CO₂ cylinder, which is provided separately being not a part of the system (10). The CO₂ cylinder is connected to the valves and opens as per the programmed logic for a pre defined interval or duration, based on the input received from either the gas sensors (66) or input defined by the user in the interfacing unit (90). Thus, the gaseous exchange unit (67) provides CO₂ supplementation for increased CO₂ assimilation at predefined specific periods of the day or based on the gaseous composition, thereby allowing limited air exchange for a predefined period, which is good enough for the gaseous ratio to balance and maintain equilibrium. But simulantenously also maintains internal heat or cool air by preventing loss of the internal heat or cool air as per the requirement. The increased CO₂ assimilation is due to any factor which increases the stomatal aperture for increasing transpiration rate, like the root temperature, or other factors, which thereby allows more CO₂ to enter the plant and get assimilated. The air from the external enviornement passes through an air filter (65) before entring the plant grwoth chamber (20) for providing pathogen free clean air. The air filter (65) can be like HEPA, ULPA or the like. This air is then conditioned through the conditioning unit i.e. either cooled or warmed and evenly circulated through a fan (69), which is placed at the top of the plant growth chamber (20). The air is then passed through the sides of the trays (22) from all the sides of the plant growth chamber (20).

The intelligent integrated plant growth system (10) also includes an imaging unit (70) which is configured to image the plant (30) at predefined intervals or at desired time for monitoring the plant growth for analysing the phenotypic, physiological and the like growth and development parameters of the plant (30). The analysis can include the types like growth curve analysis, phenotypic analysis and morphometric analysis, which is due to change in growth parameters or genetic change. The image is stored in an image database (71), for processing, using an analytical tool like the image analysis software for plant morphometry, phenomics and special geometries, and feature extraction devices as per the predefined criteria. The image is classified and ranked for storing in image database (71). The image thus enables the user to analyze and compare with prior data to identify trends and patterns, for subsequent selection or alteration in the management regimes. The imaging unit (70) can be a camera or other imaging device, which can move on XYZ axis i.e. on a camera carriage unit (72) for top and side imaging of the plants (30). The cameras or imaging units (70) can be either web enabled or remotely operated and therefore can automatically take images at predefined intervals. The images then be stored in image database (71) after basic image processing as discussed above by the imaging control unit (73). The image can also be stored on a remote server, which can be accessed and analysed later for decision making and for growth control based on feedback loop. The image analysis can be done for growth rate analysis, any phenotypic or morphometric changes that occur due to changes in any of the growth parameters like abiotic (temperature, humidity, CO2, Light, water, nutrient, pH etc.) and biotic (bacterial, fungal, viral, insect, etc) environment, or genetic changes in the plants (30). The imaging unit (70) is controlled by the imaging control unit (73) based on user defined specifications. The imaging unit (70) or camera can be a normal visual (RBG camera), or other types of camera like NIR, SWIR, IR, Fluoroscence, Hyperspectral, Depth or Laser based 3D Cameras, or Stereoscopic Depth Cameras etc.

The system (10) also includes a power unit (80) which is configured to supply electric power for the functioning of the system (10) for the growth of the plant (30). The power unit (80) can be either a conventional power source or can also be derived from solar power units. The power unit (80) can also be a UPS to provide power supply.

The system (10) also includes a music unit (76), which is connected to the primary control unit (94) to provide support to the growth of the plant (30) in the plant growth chamber (20). Certain specific sound frequencies, their combinations are known to have significant effects in the plants growth and development, therefore integrating a music unit (76) i.e. a sound generating music system with speakers (78), and volume control to generate desired sound of predefined quality with respect to tone, frequency, their combination and volume will add to desired growth rate and development of the plant (30). The music unit (76) thus pipes in various kinds of music through the speakers (78) from the music file database (77) in the database store (98) depending on the time of the day the species being grown and the stages in the life cycle of the plants (30).

The system (10) includes an interfacing unit (90) which is configured to receive the input from the user. The interfacing unit (90) can be a LCD panel or keyboeard or digital screen like touch screen that enalbes the user to input data required for controlling the parameter of the plant (30) for its growth and development. The input like various desired plant growth parameters as discussed above, is fed from the interfacing unit (90) to the central control unit (92), which further process this input. This data is then used by the expert system (91) which comprises of program to enable the hardware associated with various subystems to interact or respond with respect to the input fed by the user through the interfacing unit (90). The expert system (91) comprises of coding that enable functioning of the subsystem based on the input data. The processed input from the central control unit (92) is passed to the primary control unit (94) which is configured to output a control signal. The primary control unit (94) is connected to the nutrition control unit (48), lighting control unit (50), climate control unit (60), imaging unit (70), music unit (76) and the power unit (80) though a feedback network. The feedback network is such that the communication between the primary control unit (94) and the subsystems like nutrition control unit (48), lighting control unit (50), climate control unit (60), imaging unit (70), music unit (76) and the power unit (80) is two way i.e. the control signal is passed from the primary control unit (94) to these subsystems and the feedback signal is transferred from these subsystems to the primary control unit (94). For example, the various sensors provide their input i.e. feedback input based on their current condition and transfers it to the primary control unit (94) through the feedback network. The feedback input is then compared with the input fed by the user through the interfacing unit (90) and accordingly outputs a control signal to various subsystem control units (76, 48, 73), which thereby controls their respective subsystem devices as per the requirement to vary parameters like nutritional composition, temperature, pH, level of nutritional fluid stored in the reservoir (42) etc.

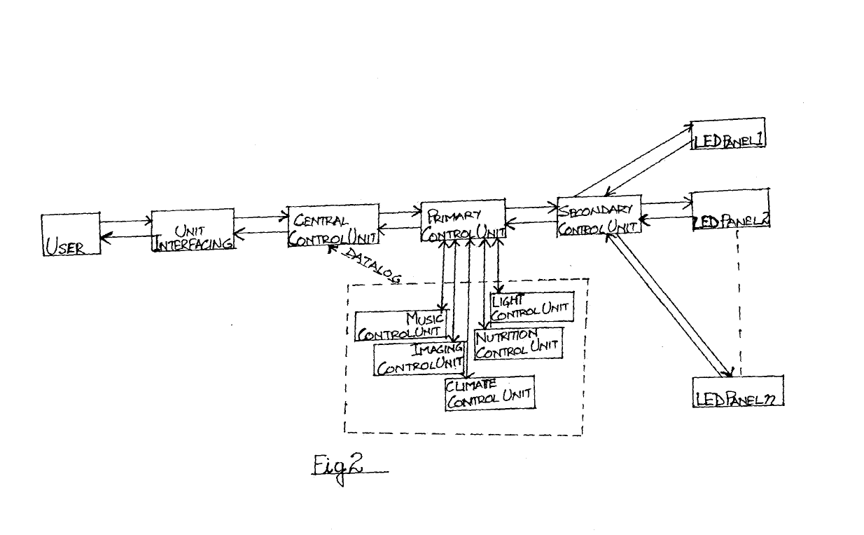

As shown in FIG. 2, the primary control unit (94) and the secondary control unit (96) functions as master slave logic for the subsystem like lighting control unit (50). The user input the desired parameters to the interfacing unit (90), which passes or transfers it to the central control unit (92). The central control unit (92) process this input based on the information or recipe available in the expert system (91) and passes or transfers it to the primary control unit (94). The primary control unit (94) also receives feedback input from various subsystem through the feedback network. The primary control unit (94) then processes both the inputs i.e. input received from the user and the feedback input and releases a control signal. This control signal either goes to the secondary control unit (96) or directly to the subsystem to manipulate or change the parameter values as desired. The subsystems continuously provide feedback to the primary control unit (94) either directly or through secondary control unit (96). This feedback is also stored in the database store (98) after processed by the central control unit, which then displays it in the user readable form through interfacing unit (90). Thus enables the user to remain updated with respect to various current values of the parameters in the intelligent integrated plant growth system (10).

The feedback network as discussed above also updates the user with the current status of the parameter values. If due to any reason, the desired parameter values deviates from its defined values either through increase or decrease, then the primary control unit (94) compares it with the defined values and accordingly releases the control signal to the particular subsystem responsible for that particular parameter values to either decrease or increase such parameter values to maintain it at the defined values. For example, if the required or defined temperature for the growth of the plant (30) be 35° C., then the external environment may drop down and affect the temperature to deviate from the defined value. Thereafter, once it drop downs, the temperature sensor in the temperature control unit (61) senses it and sends the data as a feedback input to the primary control unit (94). The primary control unit compares the feedback input with the defined or desired input fed by the user at the interfacing unit (90), and releases a control signal. This control signal is then fed or transferred to the temperature control unit (61) of the climate control unit (60), which through the conditioning unit manipulates the temperature to the desired or defined values and thereby automatically maintaining the desired or defined parameter values in the plant growth chamber (20) and thereby further making the system an intelligent integrated plant growth system.

The interfacing unit (90) is also accessed from the remote distance using a communication device (79), which enables the remote communication through Internet of Things (IoT) like through internet, wireless, Wifi, Bluetooth, Zigbee or the like radio frequency communication protocols enables the user to see the plants growing, control the growth parameters, and even changing or downloading and running of new growth recipes or programs/algorithms. It also sends alert on the plant growth status, nutrition reservoir status etc on to devices with internet, like Tablet, laptop, mobile phones etc. through an sms or email. The data related to the status of the system (10) can be accessed and the plant growth recipes can therefore be loaded on to the system (10) directly through internet connection on system (10), or through any computing device with internet access, using blue tooth or through other communication protocols.

In an alternate embodiment, the water for the nutritional fluid can be from an RO water purifier, which is membrane filtered & UV sterilised and recycle into the nutritional fluid. In low humidity areas extra filtered drinking water may be needed for making nutritional fluid. Being a closed loop system the mist and sprayed water that is unabsorbed by the plant roots, collect in the trays (22) and are drained through draining structure (26) into the reservoir (42) and before being recycled it is filtered through an inline drain filter (29) made up of steel wire mesh, polyfill. Coconut fibre, or similar material, which allows removal of the of clogging material and cleaning of the filter.

In an alternate embodiment, the manual over ride or diagnostic feature is provided in the system (10), which enables the user to run and control subsystem parameters, and control features separately as well as individually or in combination to diagnose the the faults in its functioning.

1. An intelligent integrated plant growth system comprising:
a plant growth chamber having at least a tray with a base adapted to hold at least a plant, a distributing structure to distribute a nutritional fluid within said tray to the roots of said plant and a draining structure to drain said nutritional fluid from said base of said tray;
a nutrition control unit having a reservoir adapted to store said nutritional fluid from said draining structure, a condensing unit configured to condense the water vapor into water with least impurities to form said nutritional fluid stored in said reservoir, a pumping unit configured to pump said nutritional fluid from said reservoir to said tray through said distributing structure, said nutrition control unit (84) is configured to control the timing of the pumping of said pumping unit to pump said nutritional fluid from said reservoir at predefined intervals;
a lighting control unit configured to provide at least a light ray of a predefined wavelength and of a predefined photosynthetic property for the growth of said plant, said predefined wavelength and said predefined photosynthetic property of said light ray is controlled by a secondary control unit;
a climate control unit configured to control at least a parameter for the growth of said plant in said plant growth chamber;
an imaging unit configured to image said plant at predefined intervals for analysing the phenotypic, physiological and the like growth and development parameters of said plant;
a power unit configured to supply electric power for the functioning of said intelligent integrated plant growth system for the growth of said plant; and
an interfacing unit configured to receive an input from a user, said input is processed by a central control unit, thereby passing processed said input to a primary control unit configured to output a control signal, said primary control unit is connected to at least any one of a secondary control unit, said nutrition control unit, said lighting control unit, said climate control unit, said imaging unit and said power unit through a feedback network, said feedback network provides a feedback input from at least any one of said secondary control unit, said nutrition control unit, said lighting control unit, said climate control unit, said imaging unit and said power unit to said primary control unit,
wherein said primary control unit processes said input and said feedback input to output said control signal, and said control signal controls at least any one of said secondary control unit, said nutrition control unit, said lighting control unit, said climate control unit, said imaging unit and said power unit based on said feedback input received from at least any one of said secondary control unit (96), said nutrition control unit, said lighting control unit, said climate control unit and said imaging unit and said power unit and said input from said interfacing unit, thereby forming said intelligent integrated plant growth system.

2. The system as recited in claim 1, wherein said predefined wavelength includes the wavelength in the range of at least any one from Red, Blue, Green, IR, NIR and White light.

3. The system as recited in claim 1, wherein said distributing structure is within at least any one of said tray and said plant growth chamber to distribute the nutritional fluid to the plant.

4. The system as recited in claim 1, wherein a plant holder supports said plant on a tray cover of said tray, said tray is provided with a locking system to enable said tray cover to cover said tray to prevent loss of said nutritional fluid and ensuring oxygenation of the roots of said plant.

5. The system as recited in claim 1, wherein said central control unit based on said input from said interfacing unit varies at least any one from a nutritional composition, temperature, a pH, a level of said nutritional fluid stored in said reservoir, and such other plant growth and development parameters, said central control unit outputs said control signal to said primary control unit configured to control said at least any one of said nutrition control unit, said lighting control unit, said climate control unit, said imaging unit and said power unit based on said feedback input and said input, said primary control unit outputs said control signal to said secondary control unit configured to control light parameters of said plant.

6. The system as recited in claim 1, wherein said climate control unit includes: a temperature control unit having a temperature sensor, and a conditioning unit to maintain predefined temperature, at predefined time, or creation of temporal gradients of temperature for day and night for the growth of said plant in said plant growth chamber; a humidity control unit having a humidity sensor to control the humidity as per predefined level and time for the growth of said plant; and a gaseous exchange unit having at least a gas sensor to maintain gaseous balance required for the growth of said plant and a plurality valves to control the exchange of gases to maintain desired gaseous composition with desired duration and frequency.

7. The system as recited in claim 1, wherein said photosynthetic property includes at least any one from light duration, light intensity and combinations of said predefined wavelength.

8. The system as recited in claim 1, wherein said imaging unit images said plant to form an image at predefined intervals for image analysis of said plant for at least any one from growth curve analysis, phenotypic analysis, morphometric analysis, physiological analysis and genetic screening due to changes in at least any one from growth parameters and genetic changes, said image of said plant is stored in an image database for analyses using an image analysis software for plant morphometry and phenomics.

9. The system as recited in claim 1, wherein said primary control unit is connected to a music unit to provide support to the growth of the plant in said plant growth chamber, and said interfacing unit is accessed from remote distance using a communicating device.

10. A process for growing a plant in an intelligent integrated plant growth system comprising the steps of:
placing the plant in a plant growth chamber having at least a tray with a base to hold the plant;
controlling a nutritional fluid by a nutrition control unit by storing said nutritional fluid in a reservoir of said nutrition control unit, condensing water vapor into water with least impurities to form said nutritional fluid stored in said reservoir, pumping said nutritional fluid at predefined intervals by a pumping unit from said reservoir to said tray through a distributing structure to distribute said nutritional fluid within said tray to the roots of said plant, and draining said nutritional fluid from said base (24) of said tray by a draining structure to the reservoir of said nutrition control unit, pumping of said pumping unit is controlled by said nutrition control unit;
providing at least a light ray of at least a predefined wavelength and of a predefined photosynthetic property by a lighting control unit for the growth of said plant, said predefined wavelength and said predefined photosynthetic property of said light ray is controlled by a secondary control unit;
climatizing the plant growth chamber by an climate control unit by controlling at least a parameter for the growth of the plant in said plant growth chamber;
imaging said plant by an imaging unit at predefined intervals for analysing the growth of said plant in the plant growth chamber;
powering said intelligent integrated plant growth system by a power unit to supply electric power for the functioning of said intelligent integrated plant growth system for the growth of the plant; and
receiving an input from a user by an interfacing unit, processing said input by a central control unit to output processed said input data passes to a primary control unit configured to output a control signal, said primary control unit is connected to at least any one of a secondary control unit, said nutrition control unit, said lighting control unit, said climate control unit said imaging unit and said power unit through a feedback network, providing a feedback input by said feedback network from at least any one of said secondary control unit, said nutrition control unit, said lighting control unit, said climate control unit, said imaging unit and said power unit to said primary control unit and processing said input and said feedback input to output said control signal to control at least any one of said secondary control unit, said nutrition control unit, said lighting control unit, said climate control unit, said imaging unit and said power unit by said central control unit based-on said feedback input and said input from said interfacing unit.

11. The process as recited in claim 10, including providing the light ray of the predefined wavelength in the range of at least any of Red, Blue, Green, IR, NIR and White light.

12. The process as recited in claim 10, including distributing said nutritional fluid from the reservoir to the roots of said plant by said distributing structure within at least any one of said tray and said plant growth chamber.

13. The process recited in claim 10, including distributing said nutritional fluid from the reservoir to the roots of said plant by said distributing structure within at least any one of said tray and said plant growth chamber.

14. The process as recited in claim 10, including varying at least any one from a nutritional composition, temperature, a pH, a level of said nutritional fluid stored in said reservoir and such other plant growth and development parameters, by said central control unit based on said input from said interfacing unit, said central control unit outputs said control signal to said primary control unit configured to control said at least any one of said nutrition control unit, said lighting control unit, said climate control unit, said imaging unit and said power unit based on said feedback input and said input, said primary control unit outputs said control signal to said secondary control unit configured to control light parameters of said plant.

15. The process as recited in claim 10, including climatizing the plant growth chamber by maintaining: the predefined predefined level and for a predefined time for the growth of said plant by a humidity control unit including a humidity sensor in said climate control unit; and
gaseous balance and gaseous composition with desired duration and frequency required for the growth of said plant by a gaseous exchange unit having at least a gas sensor and a plurality of valves in said climate control unit.

16. The process as recited in claim 10, including providing the light ray with said photosynthetic property including at least any one from light duration, light intensity and combinations of said predefined wavelength.

17. The process as recited in claim 10, including imaging the plant to form an image at predefined intervals by said imaging unit for analysing said image of said plant for at least any one from growth curve analysis. phenotypic analysis, morphometric analysis, physiological analysis and genetic screening due to changes in at least any one from, growth parameters and genetic changes, said image of said plant is stored in an image database for analyses using an image analysis software for plant morphometry and phenomics.

18. The process as recited in claim 10, including providing music by a music unit connected to said primary control unit to enhance the growth of said plant and enabling said user to access said inputs from remote distance by a communicating device by said interfacing unit.

19. The process as recited in claim 10, including processing said input by said central control unit from said Interfacing unit to vary at least any one of a plant growth parameters from nutritional composition, nutritional concentration, temperature, pH, level of the fluid stored in said reservoir, frequency and dose, Light intensity of said light ray, duration of providing the light ray, the predefined wavelength, predefined photosynthetic property, air temperature, air velocity, air composition, humidity percentage, sound frequency, sound volume, sound wavelength, sound composition and the like.
